(19) United States
(12) Patent Application Publication
(10) Pub. No.: US 2009/0032571 A1
(43) Pub. Date: Feb. 5, 2009

(54) METHODS AND SYSTEMS FOR WELDING PARTICLE-MATRIX COMPOSITE BODIES

(75) Inventor: Redd H. Smith, The Woodlands, TX (US)

Correspondence Address: TRASK BRITT, P.O. BOX 2550, SALT LAKE CITY, UT, 84110, US

(73) Assignee: BAKER HUGHES INCORPORATED, Houston, TX (US)

(21) Appl. No.: 11/833,510

(22) Filed: Aug. 3, 2007

(51) Int. Cl. B23K 37/04; B23K 5/00; B23K 9/00

(52) U.S. Cl. 228/196; 219/121.14; 219/121.64; 219/136; 219/600; 219/74; 219/75; 228/48

(57) ABSTRACT

Methods and associated systems for welding a particle-matrix composite body to another body are disclosed. In some embodiments, a particle-matrix bit body may be welded to a metal coupler. In one embodiment, a heating torch may heat a first localized volume of the particle-matrix composite body to a temperature below the melting temperature of the matrix material of the particle-matrix composite body. A welding torch may simultaneously melt a second localized volume proximate the first localized volume to a temperature above the melting temperature of the matrix material of the particle-matrix composite body to weld the particle-matrix composite body to another body.

### FIELD OF THE INVENTION

The invention relates generally to methods of welding materials susceptible to thermal shock, and to systems used for such welding. More particularly, embodiments of the invention relate to methods and systems for welding a particle-matrix composite body to another body. Embodiments of the invention additionally relate to methods and systems for joining a particle-matrix composite bit body to a metal coupler.

### BACKGROUND OF THE INVENTION

Particle-matrix composite materials may be composed of particles embedded in a matrix. For example, extremely hard particles of a refractory carbide ceramic such as tungsten carbide (WC) or titanium carbide (TiC) may be embedded in a matrix of a metal such as cobalt (Co), Nickel (Ni), or alloys thereof. These particle-matrix composite materials are used frequently for cutting tools due to improved material properties of the composite as compared to the properties of the particle material or the matrix material individually. For example, in the context of machine tool cutters, refractory carbide ceramic provides an extremely hard cutting surface but is extremely brittle and may not be able to withstand cutting stresses alone, whereas a metal may be too soft to provide a good cutting surface. However, inclusion of the refractory carbide ceramic particles in a more ductile metal matrix may isolate the hard carbide particles from one another and reduce particle-to-particle crack propagation. The resulting particle-matrix composite material may provide an extremely hard cutting surface and improved toughness.

Although particle-matrix composite materials have many favorable material properties, one difficulty in the use of particle-matrix composite materials is that welding using localized heat, such as arc welding, may cause cracks to occur in particle-matrix composite materials.

For example, U.S. Pat. No. 4,306,139 to Shinozaki et al. describes a method for welding a material comprising tungsten carbide and a Nickel and/or Cobalt binder to an iron base member. Shinozaki et al. discloses that chromium has a strong tendency to combine readily with carbon and will react with the carbon in the tungsten carbide to form carbides of chromium. As a result, the tungsten carbide is decarburized to (W.Ni)₆C or (W.Co)₆C, which very frequently appears at the boundary of the material and the weld. These carbides are a few times greater in particle size than tungsten carbide and are very brittle, and can thus cause separation of the weld and cracking. To avoid this problem a nickel-alloy filler material containing no chromium (Cr) and at least 40% nickel by weight is applied with a shielded arc welder or tungsten inert gas welder.

It has been observed however, that welding particle-matrix composite materials (for example a material comprising tungsten carbide particles in a cobalt matrix) to steel according to Shinozaki et al. may still result in cracking of the particle-matrix composite material proximate the weld.

In view of the shortcomings of the art, it would be advantageous to provide methods and associated systems that would enable the localized melting of a particle-matrix composite material without significant cracking. Additionally, it would be advantageous to provide methods and associated systems that would enable the welding of a particle-matrix composite body to another body using welding techniques involving a focused heat source, such as an electric arc or a laser, without significant cracking resulting in the particle-matrix composite body.

### BRIEF SUMMARY OF THE INVENTION

In one embodiment, a particle-matrix composite body of an earth-boring tool may be joined to a metallic body. The method may comprise heating a localized volume of a particle-matrix composite body with a heating device to an elevated first temperature below the melting temperature of the matrix material of the particle-matrix composite body. The method may further comprise heating at least a portion of the localized volume of the particle-matrix composite body with a welding torch to a second temperature greater than the melting temperature of the matrix material of the particle-matrix composite body to weld the at least a portion of the localized volume of the particle-matrix composite body to a metallic body.

In another embodiment, a particle-matrix composite bit body for an earth-boring drill bit may be joined to a metal coupler. The method may comprise heating a first localized volume of the particle-matrix composite bit body to an elevated temperature with a heating torch. The elevated temperature may be below the melting temperature of the matrix material of the particle-matrix composite body. Simultaneously, a second localized volume adjacent the first localized volume may be heated to a temperature above the melting temperature of the matrix material of the particle-matrix composite bit body with a welding torch to weld the particle-matrix composite bit body to the metal coupler.

In an additional embodiment, a system for welding a particle-matrix composite body may comprise a chuck configured to support a particle-matrix composite body, the chuck mounted for rotation on a support structure. The system may also comprise a kiln configured to receive the particle-matrix composite body, a heating torch, a welding torch mounted adjacent the heating torch, and a drive for rotating the chuck supporting the particle-matrix composite body during operation of the heating torch and the welding torch.

### BRIEF DESCRIPTION OF THE DRAWINGS

FIG. 1 shows a perspective view of an earth-boring rotary drill bit having a particle-matrix composite bit body welded to a steel coupler, in the form of a shank, according to an embodiment of the present invention.

FIG. 2 shows a cross-sectional view of the earth-boring rotary drill bit shown in FIG. 1.

FIG. 3A shows a cross-sectional view of a portion of the interface between the particle-matrix composite bit body and the steel coupler of the earth-boring rotary drill bit shown in FIG. 1 before welding.

FIG. 3B shows a cross-sectional view of a portion of the interface between the particle-matrix composite bit body and the steel coupler of the earth-boring rotary drill bit shown in FIG. 1 after welding according to an embodiment of the present invention.

FIG. 4 shows a close-up cross-sectional view of a portion of the interface between the particle-matrix composite bit body and the steel coupler shown in FIGS. 3A-3B.

FIGS. 5A-5F show a portion of a pictorial view of the interface between the particle-matrix composite bit body and the steel coupler of FIG. 1 during a welding process according to embodiments of the present invention.

FIGS. 6A-6C show side elevations of a system for welding a particle-matrix composite body to another body according to an embodiment of the present invention.

FIG. 7 shows an enlarged perspective view of a portion of the system depicted in FIGS. 6A-6C in the orientation shown in FIG. 6C.

### DETAILED DESCRIPTION OF THE INVENTION

The depth of subterranean well bores being drilled continues to increase as the number of shallow depth hydrocarbon-bearing earth formations continues to decrease. These increasing well bore depths are pressing conventional drill bits to their limits in terms of performance and durability. Several drill bits are often required to drill a single well bore, and changing a drill bit on a drill string can be expensive in terms of drilling rig time due to the necessity to withdraw or “trip out” thousands of feet of drill pipe to replace a worn drill bit, replace it with a new one, and “trip in” the new drill bit to the bottom of the well bore to resume drilling.

New particle-matrix composite materials are currently being investigated in an effort to improve the performance and durability of earth-boring rotary drill bits. Furthermore, bit bodies comprising at least some of these new particle-matrix composite materials may be formed from methods other than traditional infiltration processes used to form so-called “matrix-type” bits, wherein a mass of hard particles, conventionally of tungsten carbide (WC) is infiltrated with a molten copper alloy binder. By way of example and not limitation, bit bodies that include such new particle-matrix composite materials may be formed using powder compaction and sintering techniques. Such techniques are disclosed in pending U.S. patent application Ser. No. 11/271,153, filed Nov. 10, 2005 and pending U.S. patent application Ser. No. 11/272,439, also filed Nov. 10, 2005, the disclosure of each of which is incorporated herein in its entirety by this reference. An example of such a rotary drill bit is described further herein.

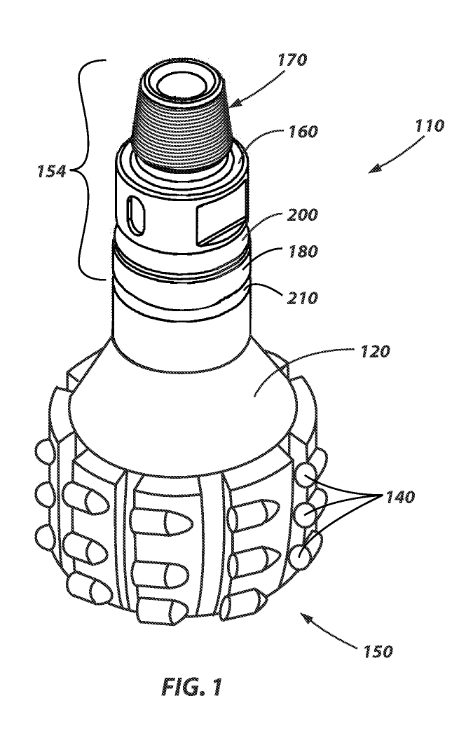

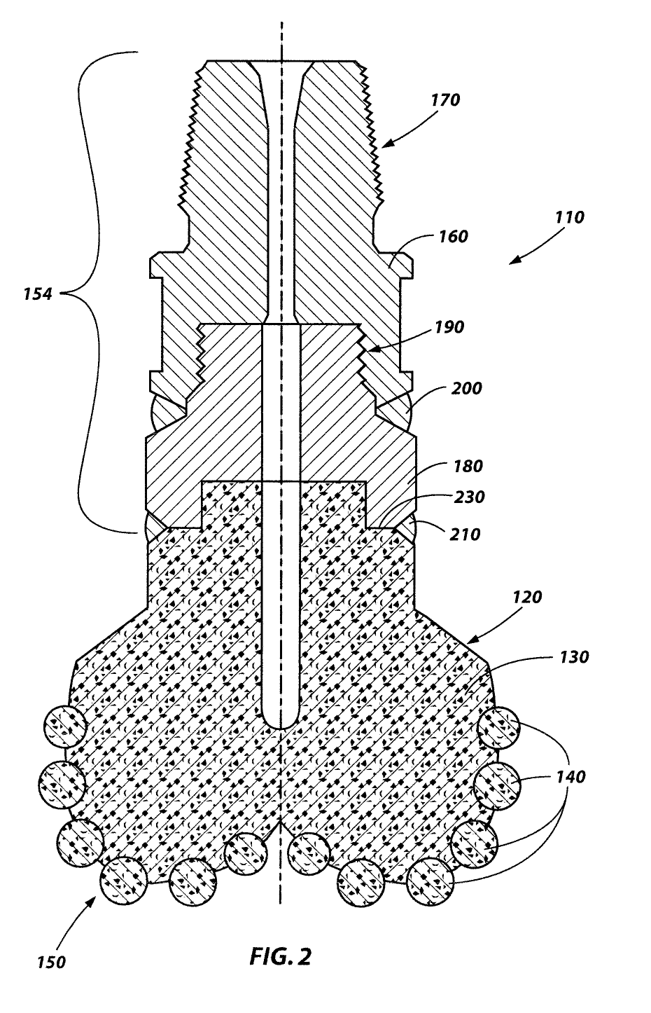

An earth-boring rotary drill bit 110 is shown in FIGS. 1 and 2 that includes a bit body 120 comprising a particle-matrix composite material 130. This example of a rotary drill bit is a fixed-cutter bit (often referred to as a “drag” bit), which includes a plurality of cutting elements 140 secured to the face region 150 of the bit body 120. The bit body 120 is secured to what may be termed a “coupler” (metal coupler 154) for directly or indirectly connecting the rotary drill bit 110 to a drill string or a downhole motor (not shown). The metal coupler 154 may comprise only a shank 160 or may comprise an assembly that includes both a shank 160 and an extension 180. The shank 160 may have an American Petroleum Institute (API) or other threaded connection 170 and may be formed from a metal such as steel. The bit body 120 may be welded directly to the shank 160 or may be secured to an extension 180, also known as a cross-over, as shown in FIGS. 1 and 2. The extension 180 may be of a similar or the same material as the shank 160. For example, the extension 180 may also comprise steel. The extension 180 may be at least partially secured to the shank 160 by a threaded connection 190 and a weld 200. The extension 180 may be at least partially secured to the bit body 120 by a weld 210 extending around the rotary drill bit 110 on an exterior surface thereof along an interface 230 between the particle-matrix composite bit body 120 and the extension 180. Using conventional welding techniques for forming the weld at the interface 230 results in unacceptable cracking of the particle-matrix composite bit body 120 proximate the weld 210. However, forming the weld 210 according to an embodiment of the present invention may reduce or eliminate the cracking in the particle-matrix composite bit body 120 that is seen using conventional methods.

As noted above, an earth-boring rotary drill bit 110 conventionally includes a shank 160, as during drilling operations the drill bit requires attachment to a drill string (not shown). For example, the earth-boring rotary drill bit 110 may be attached to a drill string by threading a steel shank 160 to the end of a drill string by the aforementioned API or other threaded connection 170. The drill string may include tubular pipe and equipment segments coupled end to end between the drill bit and other drilling equipment, such as a rotary table or a top drive, at the surface. The drill bit may be positioned at the bottom of a well bore such that the cutting elements 140 are in contact with the earth formation to be drilled. The rotary table or top drive may be used for rotating the drill string and the drill bit within the well bore. Alternatively, the shank 160 of the drill bit may be coupled directly to the drive shaft of a down-hole motor, which then may be used to rotate the drill bit, alone or in conjunction with surface rotation. Rotation of the drill bit under weight on bit (WOB) causes the cutting elements 140 to scrape across and shear away the surface of the underlying formation.

Conventionally, bit bodies that include a particle-matrix composite material have, as noted above, been termed matrix-type bits and have been fabricated in graphite molds using a so-called “infiltration” process. In this process the cavity of a graphite mold is filled with hard particulate carbide material (such as tungsten carbide, titanium carbide, tantalum carbide, etc.). A preformed steel blank (not shown) then may be positioned in the mold at an appropriate location and orientation. The steel blank may be at least partially submerged in the particulate carbide material within the mold.

A matrix material (often referred to as a “binder” material), such as a copper-based alloy, may be melted, and caused or allowed to infiltrate the particulate carbide material within the mold cavity. The mold and bit body are allowed to cool to solidify the matrix material. The steel blank is bonded to the particle-matrix composite material that forms the crown upon cooling of the bit body and solidification of the matrix material. A steel shank may then be threaded or otherwise attached to the steel blank and the blank and the shank may be welded together.

When utilizing new particle-matrix composite materials 130, which may require techniques such as powder compaction and sintering, it may not be desirable to bond a metal coupler 154, such as a steel shank 160, extension 180, or blank, to the particle-matrix composite bit body 120 during the sintering process. This is because liquid-phase sintering involves extreme temperatures that may exceed the melting temperature of the steel. Additionally, even if the sintering temperature is below the melting temperature of the steel the temperatures may still be hot enough to alter the steel such that it may no longer have desirable physical properties. As such, it may be desirable to bond a metal coupler 154 to the particle-matrix composite bit body 120 after the bit body 120 has been fully sintered.

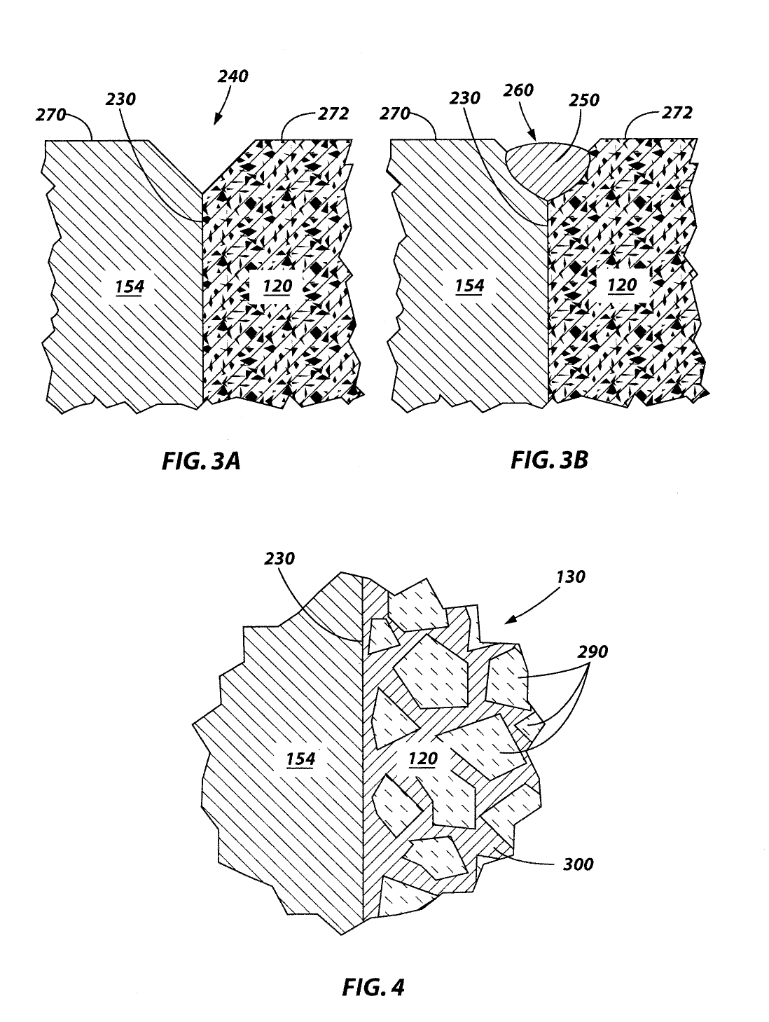

As shown in FIG. 3A, a particle-matrix composite body may abut another body in preparation for welding. For example, a particle-matrix composite bit body 120 and a metal coupler 154 may abut along an interface 230. In additional embodiments, a particle-matrix composite body may be welded to a different metallic body, including another particle-matrix composite body. A weld groove 240 may be formed along an outer edge of the interface 230. A weld groove 240 such as the generally V-shaped weld groove 240 shown may be especially useful when welding with a filler material 250, as shown in FIG. 3B. The weld groove 240 may allow more surface area of each of the abutting body 120 and metal coupler 154 to contact the weld bead 260 formed from the filler material 250 coalesced with the material from each of the body 120 and metal coupler 154. Additionally, the weld groove 240 may provide a recess for the weld bead 260 so that the weld bead 260 may not protrude substantially beyond the exterior surfaces 270 and 272 of the joined body 120 and metal coupler 154.

The differences in the materials of the particle-matrix composite bit body 120 and the metal coupler 154 shown in FIGS. 3A-3B may be more clearly shown in FIG. 4, which shows a close-up cross sectional view of the interface 230 between the particle-matrix composite bit body 120 and the metal coupler 154.

A particle-matrix composite body, such as the particle-matrix composite bit body 120, may be formed from a particle-matrix composite material 130. The particle-matrix composite material 130 may comprise a plurality of hard particles 290 dispersed throughout a matrix material 300. By way of example and not limitation, the hard particles 290 may comprise a material selected from diamond, boron carbide, boron nitride, aluminum nitride, and carbides or borides of the group consisting of W, Ti, Mo, Nb, V, Hf, Zr, Si, Ta, and Cr, and the matrix material 300 may be selected from the group consisting of iron-based alloys, nickel-based alloys, cobalt-based alloys, titanium-based alloys, aluminum-based alloys, iron and nickel-based alloys, iron and cobalt-based alloys, and nickel and cobalt-based alloys. For example, the particle-matrix composite material may comprise a plurality of tungsten carbide particles in a cobalt matrix. As used herein, the term “[metal]-based alloy” (where [metal] is any metal) means commercially pure [metal] in addition to metal alloys wherein the weight percentage of [metal] in the alloy is greater than or equal to the weight percentage of all other components of the alloy individually.

The other body may comprise any of a number of suitable materials. For example, the other body may be a metal coupler 154 comprising a metal, such as steel, as shown in this example.

If a filler material is used the filler material 250 may comprise a metal. For example, the filler material 250 may be selected from the group consisting of iron-based alloys, nickel-based alloys, cobalt-based alloys, titanium-based alloys, aluminum-based alloys, iron and nickel-based alloys, iron and cobalt-based alloys, and nickel and cobalt-based alloys. Additionally, the filler material 250 may comprise a material that is used as the matrix material 300 in the particle-matrix composite material 130, or a material that has thermal properties that are similar to the thermal properties of a material used as the matrix material 300.

The present invention recognizes that the cracking of particle-matrix composite materials 130 observed using prior art methods of arc welding may be a result of the material properties of the particle-matrix composite material 130 and the extreme heat of welding. For example, cracking may occur as a result of thermal shock caused from a localized heat source, such as an electric arc. Particle-matrix composite materials 130 may be especially susceptible to thermal shock due to the brittle nature of the particles in the composite (such as tungsten carbide), and a mismatch between the thermal expansion rates of the different materials, such as the particles and the matrix material 300 of the composite material and the filler material 250 used for welding.

When an object is heated or cooled, the material of which the object is made will expand or contract. When an object is heated or cooled quickly or when heat is applied to or removed from a specific volume of the object, a temperature distribution or temperature gradient will occur within the object. A temperature gradient will result in some volumes of the material expanding or contracting more than other volumes of the material. As a result of a temperature gradient within the object, thermal stresses may be introduced as different dimensional changes in the object may constrain the free expansion or contraction of adjacent volumes within the object. For example, when an extreme heat is applied at the outer surface of an object the quickly heated volume near the heat source may expand more than the adjacent volumes of the object. This may result in compressive stresses near the heat source balanced by tensile stresses in the adjacent volumes. With quick cooling the opposite may occur, with tensile stresses at the quickly cooled volume of the object and compressive stresses in the adjacent volumes. If these stresses are small enough they may be attenuated by plastic deformation in the material. Ductile materials, such as steel, may experience substantial plastic deformation before fracturing, when compared to brittle materials such as ceramics. Brittle materials may have a very small plastic deformation range; as such they may be more susceptible to fractures as a result of thermal stresses.

The heat generated from the electric arc used in arc welding creates extreme heat focused in a very small volume of the objects being welded and may cause extreme temperature gradients within an object as a result. When welding occurs on materials such as steel, the thermal stresses resulting from an applied electric arc may be attenuated by plastic deformation of the steel. However, similar thermal gradients in a particle-matrix composite material 130 may result in thermal stresses that may not be sufficiently attenuated by plastic deformation and may result in thermal shock of the particle-matrix composite material 130 resulting in fractures in the particle-matrix composite material 130.

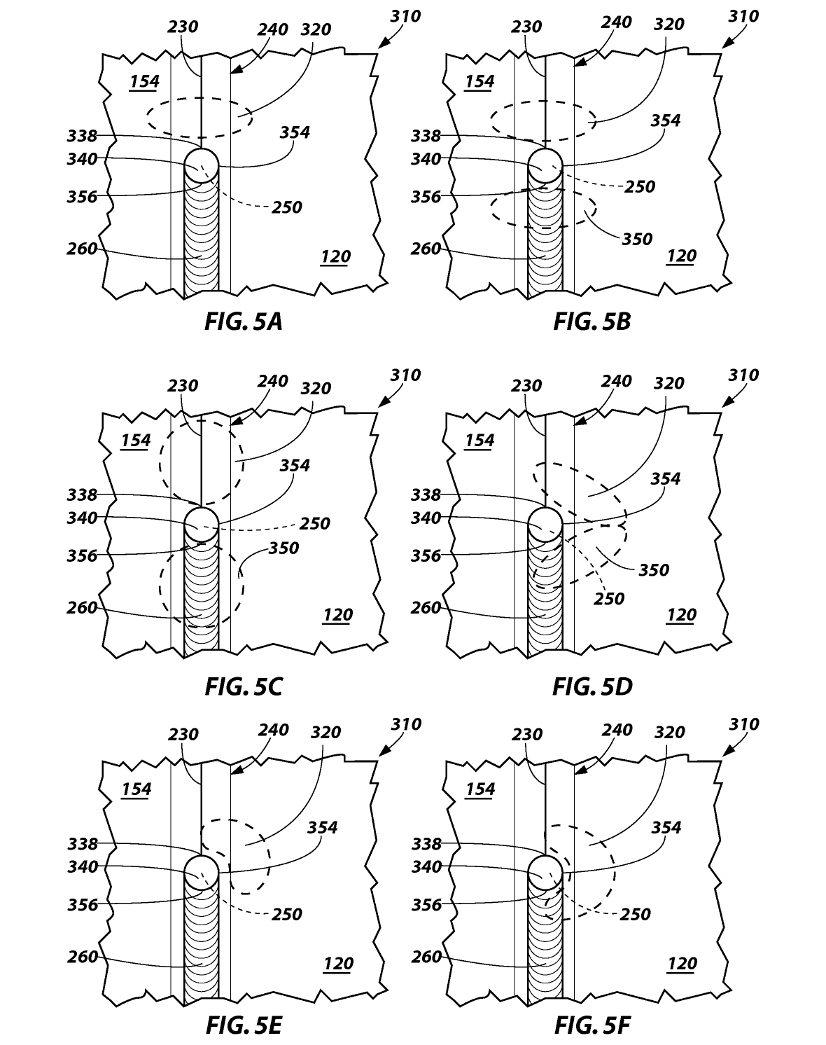

In embodiments of the invention shown in FIGS. 5A-5F, a workpiece 310 comprising a particle-matrix composite body, such as a particle-matrix composite bit body 120, and another body, such as a metal coupler 154, may be joined by welding. Joining a particle-matrix composite bit body 120 to a metal coupler 154 may comprise heating a first localized volume 320 of the particle-matrix composite bit body 120 to an elevated temperature with a heating torch. The elevated temperature may be below the melting temperature of the matrix material of the particle-matrix composite bit body 120. Simultaneously, a second localized volume proximate or adjacent the first localized volume 320 may be heated to a temperature above the melting temperature of the matrix material of the particle-matrix composite bit body 120 with a welding torch forming a weld pool 340. The welding torch may also heat and melt a portion of the metal coupler 154 as well as an optional filler material 250. The melted portion of the particle-matrix composite material 130, which may comprise solid particles suspended in the melted matrix material, and the melted portion of the metal coupler 154 may coalesce and form the weld pool 340 at the interface 230 between the particle-matrix composite bit body 120 and the metal coupler 154. The weld pool 340 may cool to form a weld bead 260, which may join the particle-matrix composite bit body 120 to the metal coupler 154. If an optional filler material 250 is used the weld pool 340 may also comprise molten filler material, which may coalesce with the melted portion of the particle-matrix composite bit body 120 and the melted portion of the metal coupler 154.

Joining a particle-matrix composite body, such as a particle-matrix composite bit body 120 of an earth-boring tool, to a metallic body, such as a metal coupler 154, may comprise heating the first localized volume 320 of a particle-matrix composite body with a heating device to an elevated first temperature below the melting temperature of the matrix material. The workpiece 310 may be rotated such that the weld bead 260 may be formed along the interface 230 between the particle-matrix composite bit body 120 and the metal coupler 154. As the workpiece 310 moves relative to the heating torch and the welding torch, at least a portion of the localized volume of the particle-matrix composite bit body 120 may be temporarily positioned proximate the welding torch. The welding torch may heat at least a portion of the first localized volume 320 of the particle-matrix composite bit body 120 to a second temperature greater than the melting temperature of the matrix material of the particle-matrix composite bit body 120 to weld particle-matrix composite bit body 120 to the metal coupler 154.

As shown in FIG. 5A, a heating torch may be used to heat a first localized volume 320 proximate the leading edge 338 of the weld pool 340, as a weld bead 260 is formed along the interface 230. The heating torch may provide heat at the interface 230 between the particle-matrix composite bit body 120 and the metal coupler 154 and may heat a localized volume of each body. The torch may be a fuel/oxygen-type torch that uses a fuel, such as acetylene, propane, hydrogen, or other fuels known in the art, that may be combusted with oxygen, such as the oxygen naturally occurring in air or a supplied substantially pure oxygen. The fuel/oxygen mixture may be adjusted so that the flame may combust all of the reactants (a neutral flame) or the flame may be fuel rich having more fuel than can be combusted by the available oxygen (a reducing flame). A neutral or a reducing flame may reduce the oxidization that may occur at the surface of the particle-matrix composite body, the other body, and/or the filler material, which may be especially susceptible to oxidization at elevated temperatures. If hydrogen fuel is used it may be desirable to supply excess hydrogen to the torch to aid in the removal of any adhering oxides on the particle-matrix composite bit body 120 and the metal coupler 154. If a hydrocarbon fuel such as acetylene is used, a neutral flame, or slightly reducing flame, may be desirable that may result in the combustion of substantially all of the oxygen to prevent oxidation of the heated particle-matrix composite bit body 120 and the metal coupler 154.

The size and shape of the localized volume that may be heated by the heating torch may be determined by the nozzle configuration and orientation of the torch. For example, the nozzle may be configured to direct a flame in a fanned out or diffused configuration. This may enable a localized volume to be heated that is larger than the portion of the material that may be melted by the welding torch. By heating the localized volume prior to melting the matrix material of a portion of the localized volume of the particle-matrix composite material, the thermal stress experienced by the particle-matrix composite bit body 120 may be reduced. The reduction of thermal stresses may eliminate or reduce thermal shock within the particle-matrix composite bit body 120. Welding according to the present invention may reduce thermal stresses in particle-matrix composite bodies by a slower transition of temperature changes and a thermal gradient that is spread out over a larger volume of material.

The heating torch and the welding torch may be operated simultaneously and may be positioned such that a portion of the localized volume heated by the heating torch may also be heated above the melting temperature of the matrix material by the welding torch. In the embodiment shown in FIG. 5A, the workpiece 310 may be moved relative to the heating torch and the welding torch, such that the heating torch proceeds the welding torch. In this configuration the heating torch may heat the localized volume of the particle-matrix composite material prior to the welding torch melting a portion of the localized volume.

In an additional embodiment, a second heating torch may be operated simultaneously with the first heating torch to provide heat to at least another volume 350 of the particle-matrix composite material as shown in FIGS. 5B-5D. In this configuration the first heating torch may heat a localized volume of the particle-matrix composite material prior to the welding torch melting a portion of the localized volume and the second heating torch may provide heat to some or all of the localized volume after welding. By providing heat to the localized volume after creating the weld pool 340, the rate of cooling may be reduced and the temperature gradient within the particle-matrix composite bit body 120 may be spread over a larger volume, which may result in the reduction of thermal stresses in the bit body 120.

Optionally, one heating torch may be used to provide heat to a localized volume after the welding torch has melted a portion of the localized volume to provide a weld without another torch heating the localized volume prior to welding.

FIGS. 5D-5F show embodiments of the present invention wherein one or more heating torches may provide heat primarily to the particle-matrix composite bit body 120. This configuration may direct the majority of the heat from the one or more heating torches to the particle-matrix composite material while providing less heat to the abutting material. If a steel body, such as a metal coupler 154, is welded to a particle-matrix composite body, such as a particle-matrix composite bit body 120, it may be desirable to minimize the heat provided to the steel. Steel components are often manufactured to exhibit desirable physical and chemical characteristics. Certain physical and chemical characteristics, such as the microstructure of the steel, may be affected by heat. For example, the properties of steel may be altered by heat treatment methods such as annealing, case hardening, precipitation strengthening, tempering and quenching. The temperature, chemical environment, and rate of heating and cooling of the steel may be used to affect changes in the physical and chemical properties of the steel. It may be desirable to control the heat provided to a steel body during welding, as excessive heat or uncontrolled heating and cooling rates may have undesirable effects on the properties of the steel. As such, the arrangement of one or more heating torches may be positioned and oriented, and the torch nozzles themselves configured, such that the majority of the heat, or substantially all of the heat, from one or more heating torches is directed to the particle-matrix composite bit body 120.

As shown in FIGS. 5E-5F, a heating torch may be configured to heat a volume of the particle-matrix composite body having a non-uniform shape. The heating torch may heat a volume of the particle-matrix composite material 130 that is proximate or adjacent both the leading edge 338 and a side 354 of the weld pool 340 as shown in FIG. 5E. Additionally, the heating torch may heat a volume of the particle-matrix composite material that is proximate or adjacent both the leading edge 338, a side 354, and the trailing edge 356 of the weld pool 340 as shown in FIG. 5F. The size and shape of the heated volume and location relative to the weld pool 340 may be adjusted, such that a desired heating and cooling rate of the particle-matrix composite bit body 120 may be achieved and/or so that the thermal gradient within the particle-matrix composite bit body 120 may be distributed over a specific volume.

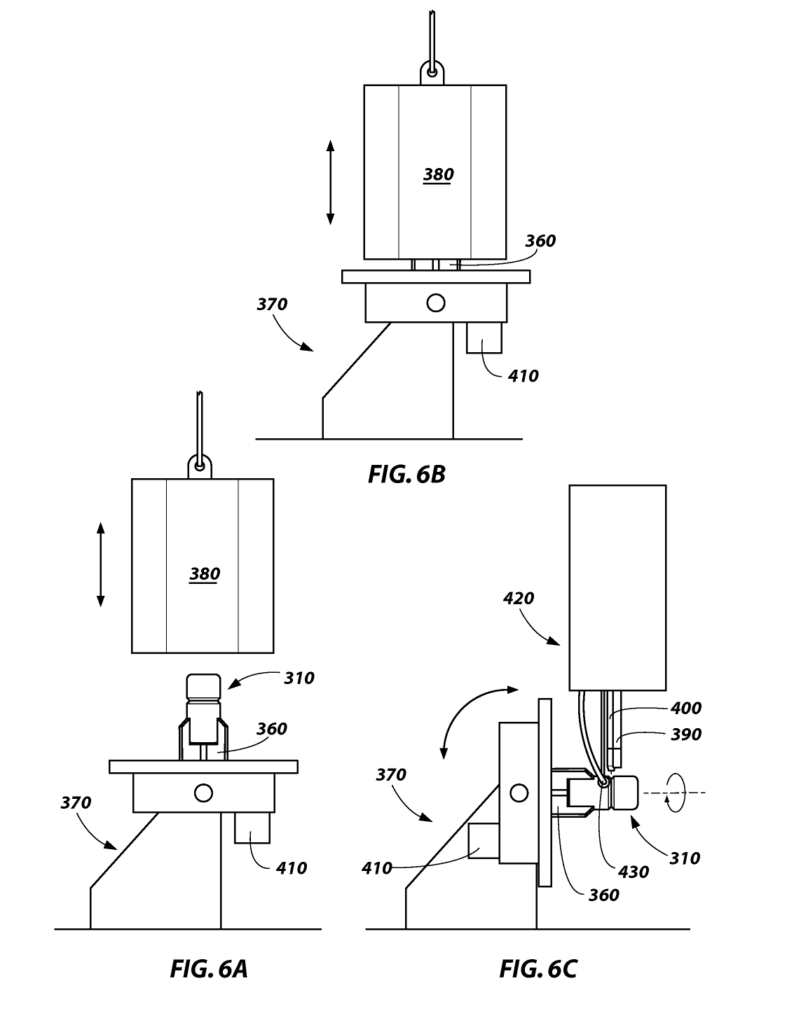

FIGS. 6A-6C show an embodiment of a system for welding a particle-matrix composite body. The system includes a chuck 360 configured to hold a particle-matrix composite body, the chuck 360 mounted for rotation between a vertical position and a horizontal position on a support structure 370. The system also includes a kiln 380 configured to receive the particle-matrix composite body, as shown in FIGS. 6A and 6B, as well as a heating torch 390 and a welding torch 400 mounted adjacent the heating torch 390, as shown in FIG. 6C. Additionally, the system includes a drive 410, such as an electric motor or a hydraulic motor mechanically coupled to the chuck 360, for rotating the chuck 360 and the particle-matrix composite body during operation of the heating torch 390 and the welding torch 400.

As shown in FIG. 6A a workpiece 310 may be mounted in the chuck 360. The workpiece 310 may comprise a particle-matrix composite bit body 120 (FIG. 1) that may be mounted directly in the chuck 360 or may be mounted to the chuck 360 by another body, such as a metal coupler 154 (FIG. 1) that may be mounted in the chuck 360 and attached to the particle-matrix composite bit body 120. The chuck 360 and the particle-matrix composite bit body 120 may be positioned below a bottom-loading kiln 380. The bottom-loading kiln 380 may be mounted to an overhead structure, such as an overhead crane (not shown), and may be lowered over the particle-matrix composite bit body 120, as shown in FIG. 6B. The kiln 380 may heat the particle-matrix composite bit body 120 to an elevated temperature. For example, the kiln 380 may heat an outer surface or substantially all of the particle-matrix composite bit body 120 to a temperature of about 800° F. to 1000° F. After the particle-matrix composite bit body 120 has been heated to a desired temperature, the kiln 380 may be lifted off of the particle-matrix composite bit body 120, such as shown in FIG. 6A. The chuck assembly may be rotated approximately 90°, as shown in FIG. 6C, and a welding assembly 420 may be positioned over the particle-matrix composite bit body 120. For example, the support structure 370 may be configured to facilitate the movement of the chuck 360 from a vertical orientation (shown in FIGS. 6A-6B) to a horizontal orientation (shown in FIG. 6C).

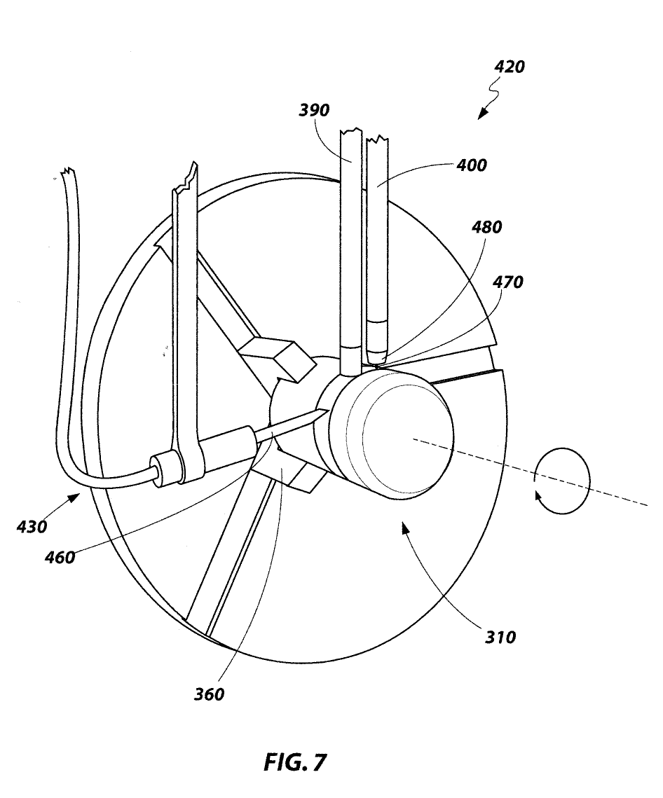

The welding assembly 420 is shown in more detail in FIG. 7. The welding assembly 420 may include at least one heating torch 390, a welding torch 400, and a seam tracker 430. The chuck 360 and the particle-matrix composite bit body 120 (FIG. 1) may be rotated about a horizontal axis relative to the welding assembly 420, as indicated in FIGS. 6C and 7. If arc welding is used for welding the particle-matrix composite bit body 120 to the metal coupler 154, a ground (not shown) may be electrically coupled to the workpiece 310 to facilitate forming an electric arc between the electrode and the workpiece 310.

The welding torch 400 and the heating torch 390 may be movable relative to the workpiece 310 as the workpiece 310 is rotated, such that multiple weld passes may be made and the resulting weld bead 260 may be distributed over a region proximate the interface 230 (FIG. 3B) between the particle-matrix composite bit body 120 and the other body.

The welding torch 400 may be a welding torch operable in accordance with one of many welding methods including, but not limited to: gas metal arc welding, shielded metal arc welding, flux-cored arc welding, gas tungsten arc welding, submerged arc welding, atomic hydrogen welding, carbon arc welding, oxygen acetylene welding, oxygen hydrogen welding, laser beam welding, electron beam welding, laser-hybrid welding, and induction welding. If gas metal arc welding (GMAW) is used (also known as metal inert gas (MIG) welding), or if gas tungsten arc welding (GTAW) is used (also known as tungsten inert gas (TIG) welding), an inert gas storage vessel (not shown) may be fluidly coupled to the welding torch 400. The inert gas, such as argon, may be directed around a consumable electrode 470 and act as a shielding gas to provide a substantially oxygen-free environment near the electric arc. A substantially oxygen-free environment may prevent oxidation of the metals at high heats, such as those created by the electric arc between the consumable electrode 470 and the workpiece 310. The consumable electrode 470 may comprise a metal wire that may be fed through the welding tip 480 from a spool (not shown), and may provide a filler material 250 (FIG. 3B) to the weld.

The heating torch 390 may comprise any of several types of heating torches, including but not limited to an oxygen-fuel torch, such as an oxygen acetylene torch and/or an oxygen hydrogen torch, a laser beam, an electron beam, and an inductor. If the heating torch 390 comprises an oxygen-fuel torch, an oxygen storage vessel and a fuel storage vessel (not shown) may each be fluidly coupled to the heating torch 390. For example, the fuel may be hydrogen, or may be a hydrocarbon fuel such as acetylene or propane. The oxygen provided may be oxygen naturally found in air, or it may be substantially pure oxygen. The nozzle of the oxygen-fuel torch may be oriented such that if an inert shielding gas is used with the welding torch the gases and flame from the heating torch may not substantially disturb the inert shielding gas proximate the welding torch 400.

A seam tracker 430 may be used that includes a positioning system (not shown) to control the position of the welding torch 400 and/or the heating torch 390 relative to the interface 230 between the particle-matrix composite bit body 120 (FIG. 3A) and the other body. For example, the seam tracker 430 may comprise a probe 460 that may be deflected upon contact with the workpiece 310 and the seam tracker 430 may provide data to the positioning system indicating presence of the workpiece 310 and initiate welding and rotation of the workpiece 310. The probe 460 may drag along the surface of the workpiece 310 and the seam tracker 430 may provide data to the positioning system to indicate surface variations so that the positioning system may generally maintain the welding torch 400 and the heating torch 390 at a specified distance from the surface of the workpiece 310 and may generally maintain the position of the welding torch 400 and the heating torch 390 proximate the interface 230 as the workpiece 310 is rotated relative to the welding assembly 420. In additional embodiments an optical or laser seam tracker (not shown) may be used. An optical or laser seam tracker may not require a mechanical probe to contact the surface of the workpiece 310, but rather may sense the location of the workpiece 310 relative to the seam tracker 430 using an optical sensor and a laser.

The welding assembly 420 may be configured with any suitable number of heating torches 390, such that the welding assembly 420 may be operated to weld as previously described herein with reference to FIGS. 5A-5F, or in any number of other suitable configurations.

In light of the above disclosure it will be appreciated that the apparatus and methods depicted and described herein enable effective welding of particle-matrix composite materials. The invention may further be useful for a variety of other applications other than the specific examples provided. For example, the described systems and methods may be useful for welding and/or melting of materials that are susceptible to thermal shock.

While the invention may be susceptible to various modifications and alternative forms, specific embodiments of which have been shown by way of example in the drawings and have been described in detail herein, it should be understood that the invention is not intended to be limited to the particular forms disclosed. Rather, the invention includes all modifications, equivalents, and alternatives falling within the scope of the invention as defined by the following appended claims and their legal equivalents.

What is claimed is:

1. A method of joining a particle-matrix composite body of an earth-boring tool to a metallic body, the method comprising:
placing a particle-matrix composite body adjacent to a metallic body;
heating a localized volume of the particle-matrix composite body to an elevated first temperature below the melting temperature of the matrix material of the particle-matrix composite body; and
heating at least a portion of the localized volume of the particle-matrix composite body to a second temperature greater than the melting temperature of the matrix material of the particle-matrix composite body to weld the at least a portion of the localized volume of the particle-matrix composite body to the metallic body.

2. The method of claim 1, wherein heating a localized volume of the particle-matrix composite body comprises heating a localized volume of the particle-matrix composite bit body.

3. The method of claim 2, further comprising heating the localized volume of the particle-matrix composite bit body to the elevated first temperature prior to heating the at least a portion of the localized volume of the particle-matrix composite bit body to a second temperature.

4. The method of claim 2, further comprising heating the at least a portion of the localized volume of the particle-matrix composite bit body to the second temperature prior to heating the localized volume of the particle-matrix composite bit body to the elevated first temperature.

5. The method of claim 2, further comprising heating at least a majority of the particle-matrix composite bit body to an elevated third temperature less than the elevated first temperature prior to heating the localized volume to the elevated first temperature.

6. The method of claim 2, wherein heating at least a portion of the localized volume of the particle-matrix composite bit body to a second temperature greater than the melting temperature of the matrix material of the particle-matrix composite body to weld the at least a portion of the localized volume of the particle-matrix composite bit body to a metallic body comprises one of gas metal arc welding, shielded metal arc welding, flux-cored arc welding, gas tungsten arc welding, submerged arc welding, atomic hydrogen welding, carbon arc welding, oxygen acetylene welding, oxygen hydrogen welding, laser beam welding, electron beam welding, laser-hybrid welding, and induction welding.

7. The method of claim 6, wherein heating a localized volume of a particle-matrix composite bit body comprises heating the localized volume of the particle-matrix composite bit body with one of an oxygen-fuel torch, a laser beam, an electron beam, and an inductor.

8. The method of claim 7, wherein welding the at least a portion of the localized volume of the particle-matrix composite bit body to the metallic body comprises melting a filler material.

9. The method of claim 8, wherein melting a filler material comprises melting a filler material selected from the group consisting of iron-based alloys, nickel-based alloys, cobalt-based alloys, titanium-based alloys, aluminum-based alloys, iron and nickel-based alloys, iron and cobalt-based alloys, and nickel and cobalt-based alloys.

10. The method of claim 6, wherein heating the localized volume of the particle-matrix composite bit body comprises heating the localized volume of the particle-matrix composite bit body with a reducing flame.

11. A method of joining a particle-matrix composite bit body to a metal coupler, the method comprising:
placing a particle-matrix composite bit body in contact with a metal coupler;
heating a first localized volume of the particle-matrix composite bit body to an elevated temperature below the melting temperature of the matrix material of the particle-matrix composite bit body with a heating torch; and
simultaneously heating a second localized volume proximate the first localized volume to a temperature above the melting temperature of the matrix material of the particle-matrix composite bit body with a welding torch to weld the particle-matrix composite bit body to the metal coupler.

12. The method of claim 11, comprising:
positioning an interface between the particle-matrix composite bit body and the metal coupler proximate the welding torch; and
rotating the particle-matrix composite bit body and the metal coupler relative to the heating torch and the welding torch so that each of the first localized volume and the second localized volume of the particle-matrix composite bit body pass proximate each of the heating torch and the welding torch.

13. The method of claim 12, wherein rotating the particle-matrix composite bit body and the metal coupler further comprises rotating the particle-matrix composite bit body and the metal coupler so that each of the first localized volume and the second localized volume passes proximate the heating torch prior to passing proximate the welding torch.

14. The method of claim 12, wherein rotating the particle-matrix composite bit body and the metal coupler further comprises rotating the particle-matrix composite bit body and the metal coupler so that each of the first localized volume and the second localized volume passes proximate the welding torch prior to passing proximate the heating torch.

15. A system for welding a particle-matrix composite body, the system comprising:
a chuck mounted for rotation on a support structure and configured to support a particle-matrix composite body;
a kiln sized and configured to receive the particle-matrix composite body;
a heating torch;
a welding torch mounted adjacent the heating torch; and
a drive for rotating the chuck and the particle-matrix composite body in proximity to the heating torch and the welding torch during operation thereof.

16. The system of claim 15, further comprising:
an oxygen source and a fuel storage source each coupled to the heating torch; and
an inert gas source coupled to the welding torch.

17. The system of claim 15, wherein the kiln comprises a bottom-loading kiln.

18. The system of claim 17, wherein the support structure is configured to facilitate the movement of the chuck from a vertical orientation to a horizontal orientation.
